(19) United States
(12) Patent Application Publication
(10) Pub. No.: US 2008/0265223 A1
(43) Pub. Date: Oct. 30, 2008

(54) Fire-retardant compositions and methods of making and using same

(75) Inventors: Ros Sopheap, Grand Island, NY (US); Jun Zhang, Getzville, NY (US)

Correspondence Address: MILBANK, TWEED, HADLEY & MCCLOY LLP, INTERNATIONAL SQUARE BUILDING, 1850 K STRET, N.W., SUITE 1100, WASHINGTON, DC, 20006, US

(73) Assignee: Osmose, Inc.

(21) Appl. No.: 11/790,255

(22) Filed: Apr. 24, 2007

(51) Int. Cl. C09K 21/00; B32B 21/04

(52) U.S. Cl. 252/607; 252/601; 428/537.1

(57) ABSTRACT

The present invention provides fire-retardant compositions for treatment of wood products comprising a guanidine phosphate compound and a boron compound, such as boric acid. The present invention also provides a method for using the compositions for preparing a fire-retardant cellulosic material, such as wood, comprising the step of applying a fire-retardant composition comprising an aqueous solution of guanidine phosphate and a boron-containing compound to a cellulosic material, thereby rendering the cellulosic material fire retardant. The present invention also provides a method of preparing a fire-retardant composition comprising mixing a guanidine phosphate and a boron-containing compound.

### FIELD OF THE INVENTION

This invention is related generally the field of fire-retardant compositions and processes of making and using fire-retardant compositions with wood and wood products. More particularly, the invention relates to fire-retardant compositions comprising a guanidine phosphate compound and a boron compound, their use, and methods of making such compositions.

### BACKGROUND OF THE INVENTION

Fire-retardant compositions are well known for decreasing the flammability or combustibility of materials, in particular wood and wood products, and for increasing the resistance of these materials to heat and flame damage. Wood and wood products have numerous desirable qualities as construction materials, including relatively low cost, structural strength, paint-ability and stain-ability, insulating properties, wide availability, renew-ability of the resource, and pleasing aesthetically characteristics. As a result, wood and wood products are used extensively as building materials for residential and commercial applications by the construction industry. Flammability, however, is the most notable disadvantage of using wood and wood products as construction materials. The susceptibility of wood to fire-related damage leads to millions of dollars per year in property damage, and also produces significant human injury and loss of life.

In order to minimize fire related losses and to meet strict building codes in areas prone to fire, wood and wood products are commonly treated with fire-retardant chemicals to reduce the flammability and improve the performance of wood and wood products in a fire. For example, U.S. Pat. No. 3,832,316 to Juneja discloses a fire retardant for wood consisting of melamine, phosphoric acid, dicyandiamide and formaldehyde. The same inventor, Juneja, also discloses a fire-retardant composition for wood in the Canadian Patent No. 917,334 comprising urea, phosphoric acid, dicyandiamide and formaldehyde.

Several other patents, including U.S. Pat. No. 4,010,296; U.S. Pat. No. 3,137,607; and U.S. Pat. No. 2,935,471, describe fire-retardant compositions comprising dicyandiamide and phosphoric acid or a phosphate. U.S. Pat. No. 2,917,408 to Goldstein et al., describes a fire retardant for use on wood having a phosphorus-amine complex, which is a combination of phosphoric acid and dicyandiamide. Similarly, U.S. Pat. No. 3,159,503 to Goldstein et al. uses a combination of formaldehyde, phosphoric acid and dicyandiamide to impart fire-retardant properties to wood. In a slightly different approach, U.S. Pat. No. 6,652,633 discloses a fire-retardant composition based on guanylurea phosphate and boric acid. As can be deduced from these examples, a vast majority of fire-retardant compositions contain phosphoric acid or reaction by-products of phosphoric acid. Several additional examples of such phosphoric acid containing fire retardants include U.S. Pat. Nos. 4,373,010; 4,514,326; and 4,725,382. Alternately, U.S. Pat. Nos. 6,517,748 and 6,306,317 disclose a phosphate-free fire-retardant formulation containing nitrogen compounds and boron compounds.

Generally, commercial fire-retardant formulations contain: (1) various phosphate compounds, including mono-ammonium phosphate, diammonium phosphate, and ammonium polyphosphate; (2) sulfate compounds, such as ammonium sulfate, copper sulfate, and zinc sulfate; (3) halogenated compounds, such as zinc chloride and ammonium bromide; or (4) nitrogen compounds, such as dicyandiamide and urea.

Halogenated compounds such as bromine and chlorine are extremely effective and relatively inexpensive fire-retardant chemicals, making them popular materials in various formulations. Unfortunately, halogenated compounds used in fire retardants raise concerns with respect to human toxicity and environmental hazards. Such compounds are unsafe to handle and emit toxic fumes once exposed to high temperature and flame. In the case of structural fires, in many instances, toxic fumes emitted from the halogenated compounds pose as great or greater risk to humans than the actual fire itself.

Many phosphate based compounds such as ammonium phosphate, are also very effective fire-retardant chemicals, making them useful in a variety of fire-retardant formulations. Unfortunately, some phosphate compounds have a serious drawback. Phosphate compounds raise concerns with respect to their effect on the structural integrity of wood and wood products. The issue lies in that phosphate compounds hydrolyze into phosphoric acid when exposed to prolonged heat and moisture. The formation of phosphoric acid degrades the treated wood structure through an acid degradation reaction between the phosphoric acid and wood components, reducing the strength of the treated wood over time.

Nitrogen compounds also raise concerns when used in fire-retardant formulations for treating wood. Nitrogen compounds, such as urea and dicyandiamide, have undesirable hygroscopic properties. In high concentration, usually 15% or more, these chemicals can draw moisture from the air making them difficult to store for long period of time. In addition, fire-retardant formulations based on either nitrogen compounds alone or boron compounds have very limited fire-retardant performance.

Despite many efforts to address these deficiencies in fire-retardant formulations, there remains an unmet need to produce a fire-retardant composition for wood products that is environmentally friendly, has long-term thermally stability, and imparts excellent fire-retardant characteristics to wood based products. This need is addressed by the invention disclosed herein.

### SUMMARY OF THE INVENTION

The present invention provides fire-retardant compositions for treatment of wood products comprising a guanidine phosphate compound and a boron compound. In a preferred embodiment, the guanidine phosphate is one or more of mono-guanidine phosphate, di-guanidine phosphate, or tri-guanidine phosphate. In another preferred embodiment, the boron compound is one or more of boric acid, a borate such as sodium octaborate, sodium pentaborate and associated hydrates, sodium tetraborate, tetraboric acid; metaboric acid; or other salts of boron compounds. In another embodiment, the compositions may include at least one additional ingredients such as nitrogen-containing and/or phosphorus-containing compounds. In one preferred embodiment, the at least one additional ingredient is dicyandiamide, urea, guanylurea phosphate, melamine phosphate, an ammonium phosphate, a cyanamide, a diammonium phosphate, or ammonium polyphosphate.

The present invention also provides an aqueous fire-retardant composition comprising a guanidine phosphate compound and a boron-containing compound. In one preferred embodiment, the fire-retardant compositions of the present invention comprise an aqueous solution of di-guanidine phosphate and boric acid.

The fire-retardant compositions of the present invention preferably comprise guanidine phosphate and a boron compound with a weight ratio of guanidine phosphate to boron compound of between 100:1 and 1:100. In another embodiment, the composition has a guanidine phosphate to boron compound weight ratio of between 10:1 and 1:10. In another preferred embodiment, the composition has a guanidine phosphate to boron compound weight ratio of between 10:2 and 4:6. Most preferably, the composition has a guanidine phosphate to boron compound weight ratio of about 7:3.

The fire-retardant compositions of the present invention preferably comprise an aqueous solution of guanidine phosphate and a boron compound with a weight concentration of guanidine phosphate and boron compound to water of between 1.0% and 50.0%. In a preferred embodiment, the composition has a weight concentration of guanidine phosphate and boron compound to water of between 2.0% and 20.0%. Most preferably, the composition has a weight concentration of guanidine phosphate and boron compound to water of between 5.0% and 15.0%.

The present invention also provides a method for using the compositions. In a preferred embodiment, the fire-retardant composition is impregnated into the cellulosic material, such as wood, by a vacuum pressure process.

The compositions can also be used to treat materials, including wood, lumber, wood composites such as plywood, oriented strand board (OSB), medium density fiberboard (MDF), particleboard, paper, textiles, rope, and the like, with the compositions of the present invention.

The present invention also provides a method of preparing a fire-retardant composition comprising mixing a guanidine phosphate and a boron-containing compound. In one embodiment, the fire-retardant composition is prepared as an aqueous solution by mixing a guanidine phosphate and a boron compound with water. In another embodiment, di-guanidine phosphate, boric acid and water are mixed to provide the fire-retardant composition.

### BRIEF DESCRIPTION OF THE DRAWINGS

FIG. 1 depicts a comparison of weight loss results of treated wood subjected to an ASTM E-69 Fire Tube Test, in which the wood was treated with a guanidine phosphate and boric acid fire-retardant composition, and the solid retention of the fire-retardant composition varies from 2.5 pounds per cubic foot (pcf) to 5.0 pcf.

FIG. 2 depicts a comparison of the maximum tube temperature results recorded during the ASTM E-69 Fire Tube Test of wood treated with a guanidine phosphate and boric acid fire-retardant composition as solid retention of the fire-retardant composition varies from 2.5 pounds per cubic foot (pcf) to 5.0 pcf.

FIG. 3 illustrates a comparison of the subjective relative condition of various treated and untreated wood samples after being subjected to an environmental chamber at 167° F. at 75% relative humidity for 180 consecutive days. Three different fire-retardant compositions according to the invention, labeled Composition 1, Composition 2, and Composition 3 were treated with a guanidine phosphate and boric acid fire-retardant composition. The figure shows a series of pictures including Compositions 1, 2 and 3, as well as untreated wood included as a control, a water-only treated sample and a commercially-available ammonium phosphate containing fire-retardant formulation.

### DETAILED DESCRIPTION OF THE INVENTION

As used herein, the term “fire retardant” means a composition that renders the material to which it is applied more resistant to heat, flame and combustion than the same material without having the composition applied.

The fire-retardant compositions of the present invention comprise a guanidine phosphate compound and a boron-containing compound and optionally one or more nitrogen containing and/or phosphor containing compounds. Accordingly, the present invention provides a fire-retardant composition comprising a guanidine phosphate and a boron compound with or without one or more nitrogen containing and/or phosphor containing compounds. In one embodiment, the fire-retardant composition comprises an aqueous solution of a guanidine phosphate, a boron compound and water.

These compositions are used for treatment of cellulosic material, such as wood or wood products. The flammability of the wood product treated with the present composition, is less than that observed from untreated wood, or wood treated with certain conventional fire-retardant products. Wood products treated with the present compositions also have a reduced potential for (greater resistance to) thermal degradation than that observed with other phosphate containing fire retardants.

Non-limiting examples of various cellulosic products contemplated for use with the present fire-retardant compositions include lumber, plywood, oriented strand board (OSB), fiberboard including low/medium/high density fiberboard (LDF, MDF, HDF), particle board, structural composite lumber (SCL) including laminated veneer lumber (LVL), laminated strand lumber (LSL) and oriented strand lumber (OSL), wood plastic composites, paper, textiles, rope, and the like.

In one embodiment of the present invention, the fire-retardant compositions comprise a guanidine phosphate (GP) compound and a boron compound. Guanidine phosphate compounds contemplated for use in the present compositions include mono-guanidine phosphate (MGP, H₂NC(═NH)NH₂.H₃PO₄), di-guanidine phosphate (DGP, (H₂NC(═NH)NH₂)₂. H₃PO₄), and tri-guanidine phosphate (TGP, (H₂NC(═NH)NH₂)₃. H₃PO₄). The preferred guanidine phosphate is di-guanidine phosphate (also known as guanidium monohydrogen phosphate or bisguandinium phosphate) with a molecular weight of about 216. Commercially-available guanidine phosphate varies in purity and molecular weight depending on the preparation and refining processes used.

Boron compounds contemplated for use in the present compositions may include boric acid, sodium borates, such as sodium tetraborate decahydrate, sodium tetraborate pentahydrate, and disodium octaborate tetrahydrate (DOT), potassium borates, and metal borate compounds such as calcium borate, borate silicate, aluminum silicate borate hydroxide, silicate borate hydroxide fluoride, hydroxide silicate borate, sodium silicate borate, calcium silicate borate, aluminum borate, boron oxide, magnesium borate, iron borate, copper borate, and zinc borate. The preferred boron compound is boric acid.

In addition to a guanidine phosphate compound and a boron compound one or more other nitrogen-containing and/or phosphorus containing compounds, such as a dicyandiamide, urea, a guanylurea phosphate, melamine phosphate, an ammonium phosphate, a cyanamide, a diammonium phosphate, and an ammonium poly-phosphate may be included in the compositions.

The weight ratio of the guanidine phosphate compound to the boron compound in the compositions can vary from 100:1 to about 1:100. That is, about 100 parts guanidine phosphate compound to one (1) part boron compound in the first instance, and one (1) part guanidine phosphate compound to 100 parts boron compound in the second instance. In a preferred embodiment the weight ratio of guanidine phosphate to boron compound varies between about 10:1 to about 1:10. In a more preferred embodiment the weight ratio of guanidine phosphate to boron compound is between about 10:2 to about 4:6. In the most preferred embodiment, the weight ratio of guanidine phosphate to boron compound is about 7:3. In another embodiment, the compositions comprise an aqueous solution of guanidine phosphate, a boron compound and water. Accordingly, the guanidine phosphate compound and the boron-containing compound can be mixed together to make a composition concentrate. The concentrate may then be further diluted with water to make a composition for use in treating wood or wood products (treating composition), or the two components can be directly mixed with the desired amount of water to make a treating composition.

When mixed into or with water, the weight concentration of the fire-retardant chemicals (GP compound and boron compound) in the treating compositions may vary from between about 1.0% to 50.0%, depending upon the applications and treating processes. In a preferred embodiment, the weight concentration of the fire-retardant chemicals can range from between about 2.0% to 20.0%. In the most preferred embodiment, the weight concentration of the fire-retardant chemicals can range from between about 5.0% to 15.0%.

In another embodiment, the invention provides a method for treating a cellulosic material or wood product with the fire-retardant compositions. In a preferred embodiment, the treating compositions are applied to a cellulosic material using pressure or vacuum treating processes. Such pressure or vacuum treating processes include the “Empty Cell” process, the “Modified Full Cell” process, the “Full Cell” process, and any other pressure/vacuum processes which are well known to those skilled in the art. The descriptions of these processes and the standard for treating wood products can be found in the AWPA Standard Handbook (the AWPA Standards are standard procedures promulgated by and under the jurisdiction of the American Wood Preservers' Association. AWPA standard methods are well known to those of ordinary skill in the art of wood preservation, and further details of the published methods are readily available.) These standard processes are defined as described in AWPA Standard C1-03 “All Timber Products-Preservative Treatment by Pressure Processes.” In the “Empty Cell” process, prior to the introduction of preservative (in the present instance, the fire-retardant composition), materials are subjected to atmospheric air pressure (Lowry) or to higher air pressures (Rueping) of the necessary intensity and duration. In the “Modified Full Cell,” prior to introduction of preservative (fire-retardant composition), materials are subjected to a vacuum of less than 77 kPa (22 inch Hg) (sea level equivalent). A final vacuum of not less than 77 kPa (22 inch Hg) (sea level equivalent) shall be used. In the “Full Cell Process,” prior to introduction of preservative (fire-retardant composition) or during any period of condition prior to treatment, materials are subjected to a vacuum of not less than 77 kPa (22 inch Hg). A final vacuum of not less than 77 kPa (22 inch Hg) is used. Alternative methods for applying the treating compositions include dipping, soaking, spraying, brushing, diffusion into green wood, vacuum pressure impregnation, compression impregnation and any other methods known to those skilled in the art. The technique to be used is dependent on the type of material being used, the required fire-retardant characteristics, the thickness and density of the material, and many other factors associated with the application of the fire-retardant compositions. Although the present invention is described using wood to illustrate the fire-retardant treatment, other cellulosic materials are contemplated and the present compositions may be applied with equal effect.

The fire-retardant compositions of the present invention can be readily packaged and shipped to treatment facilities for treating materials, e.g., wood, and to manufacturing facilities for incorporation into materials, e.g., composite wood products such as OSB, plywood and other wood products. When used with solid wood products, treatment or incorporation can be accomplished using conventional techniques, primarily pressure treatment, wherein the product is dissolved into water to form an aqueous solution prior to treatment. When used with composite wood products, the fire-retardant composition may simply be mixed into the wood sheets, fibers, chips and/or particles (without dissolution), or may be mixed with the adhesive used to form the composite wood product. In a preferred embodiment, vacuum and/or pressure techniques are used to impregnate the wood and include either the Empty-Cell process or the Full-Cell process.

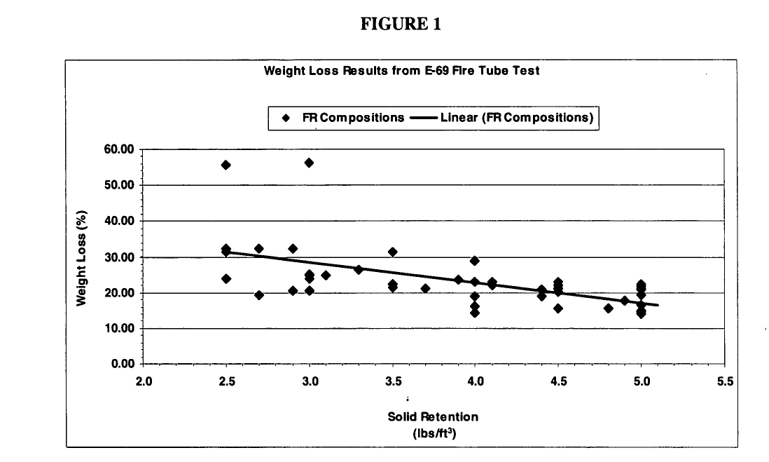

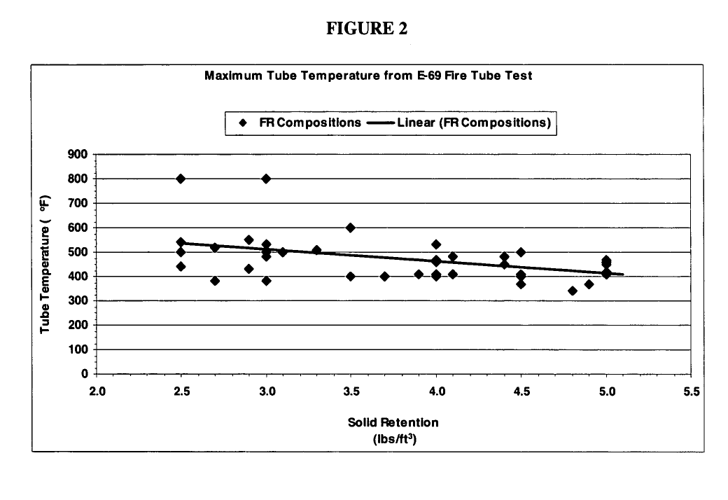

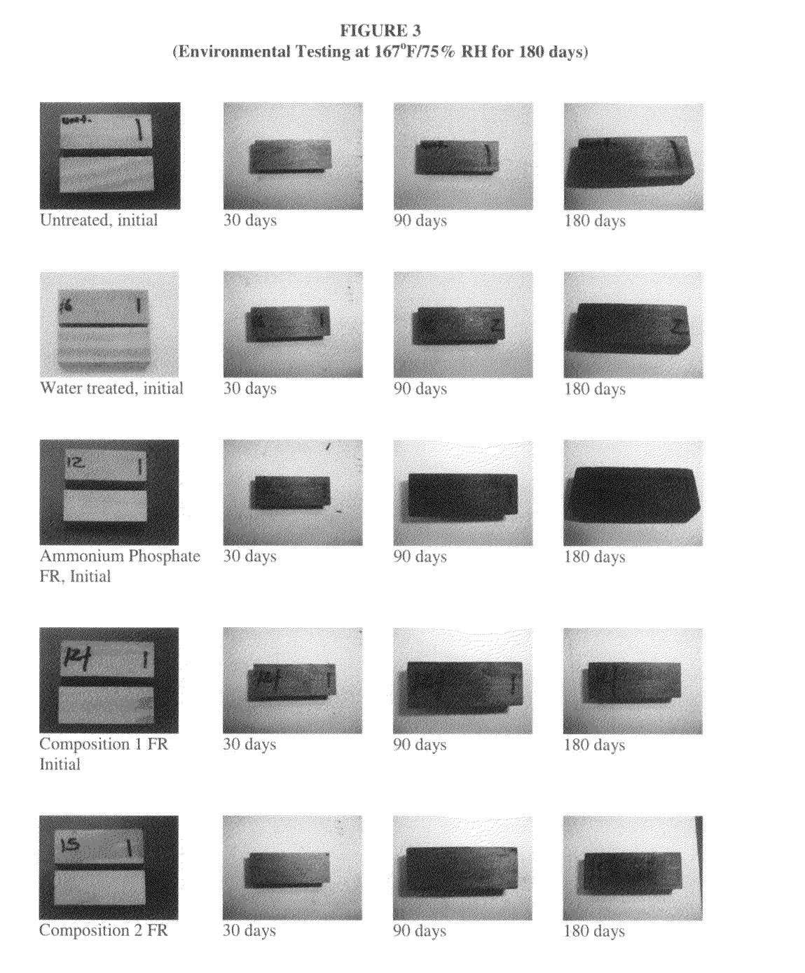

With reference to FIGS. 1 and 2, these graphs depict values resulting from a fire tube test according to American Society for Testing and Materials (ASTM) standard—ASTM E-69. The tests measure weight loss and temperature at the top of a 40″ fire tube under controlled conditions. A resultant fire tube weight loss of less than 30% and a maximum tube temperature of less than 550° F. are considered to be an acceptable fire-retardant formulation for wood products. As shown by these figures, a solid retention greater than about 3.0 pounds per cubic foot (lbs./cu. ft.) (pcf) met the maximum tube temperature and was substantially below the percent weight loss of the above standard.

When wood is treated with the fire-retardant compositions disclosed herein, percent weight loss is reduced as compared with untreated wood. Generally, as the solid retention of the treated wood is increased, the percent weight loss is reduced. For example, as shown in FIG. 1, when wood is treated with a fire-retardant composition according to the present invention as the solid retention increases, there is a corresponding decrease (generally) in the percent weight loss. This chart depicts the amount of weight loss of wood treated with several different fire-retardant compositions according to the present invention.

According to FIG. 1, at 2.5 lbs./cu. ft. (pcf) of solid retention, one possible fire-retardant composition performed extremely well with less than 25% weight loss, while two others performed near the acceptable 30% mark. As the solid retention level increased to 3.0 pcf, the majority of compositions exhibited weight loss below 25% with one out-lying composition exhibiting weight loss above 50%. When the solid retention was increased to 3.5 pcf, two compositions exhibited weight loss near 25% with one just above 30%. When the solid retention was increased to 4 pcf, all compositions exhibited weight loss below 30%, with three falling below 20%. At the 5 pcf of solid retention, five compositions exhibited weight loss below 20% with five others ranging from 20%-25%, and all 10 compositions having weight loss below the 30% level.

The over-all trend indicates that as the solid retention increase from 2.5 pcf to 5 pcf, the effectiveness, the ability to decrease the amount of weight loss of the wood, of the fire-retardant (FR) compositions increased. The results show that after 3.0 pcf, optimal fire-retardant properties are achieved with the FR compositions according to the present invention. The weight loss of the wood generally dropped below the 30% level and in many instances, the weigh loss dropped to 20% and less. The fire-retardant compositions according to the present invention have excellent fire-retardant properties, as demonstrated during the fire tube test, which protected the wood and prevented it from burning. Accordingly, the amount of weight loss of the material would be greatly reduced in the event of a fire.

When wood is treated with the fire-retardant compositions disclosed herein, the maximum temperature measured during the fire tube test is also reduced as compared with untreated wood. Generally, as the solid retention of the treated wood is increased, the maximum fire tube temperature is reduced. For example, as shown in FIG. 2, when wood is treated with a fire-retardant composition according to the present invention as the solid retention increases, there is a corresponding decrease (generally) in the maximum fire tube temperature. This chart depicts the maximum fire tube temperature recorded during the fire tube test of wood treated with several different fire-retardant compositions according to the present invention. The 800° F. limit is not a measurement of the actual combustion temperatures; it is the maximum reading the thermocouple used in the test can attain. The vast majority of fires far exceed 800° F. The acceptable fire tube temperature should not exceed 550° F.

According to FIG. 2, the trend of the graph indicates that virtually all fire-retardant compositions according to the invention that were tested had maximum fire-tube temperatures below 550° F. There were three exceptions: (1) at 2.5 pcf, one possible composition had a fire tube temperature that exceeded 800° F., corresponding to the high amount of weight loss seen in FIG. 1 for 2.5 pcf; (2) at 3.0 pcf, one composition exceeded 800° F., also corresponding with the high amount of weight loss seen in FIG. 1 for 3.0 pcf; and (3) at 3.5 pcf, another composition had a fire-tube temperature of 600° F., just above the acceptable 550° F. mark. Collectively, 80% of the fire-retardant compositions tested had fire tube temperature below 500° F.

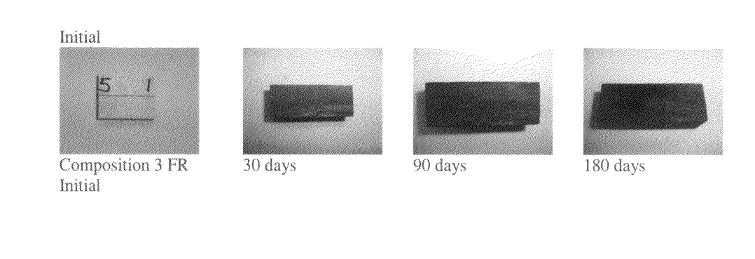

When wood is treated with the fire-retardant compositions disclosed herein, thermal stability is improved as compared with conventional phosphate based fire retardants, and is comparable to untreated wood. FIG. 3 illustrates this thermal stability characteristic. FIG. 3 shows a series of pictures showing three possible fire-retardant (FR) compositions according to the invention, that were tested for thermal stability properties at 167 degrees Fahrenheit (° F.) at 75% relative humidity (RH) for 180 consecutive days. The samples are labeled Composition 1, Composition 2, and Composition 3, respectively. Also included for testing were a control sample of untreated wood and a control sample of wood treated only with water. Also included for comparison was a wood sample treated with a commercially available ammonium phosphate containing fire-retardant (FR) composition. Photographs (shown in FIG. 3) and pH measurements of each sample were taken prior to treatment with the fire-retardant composition (excluding control samples), and are labeled as “initial” in FIG. 3. After treatment, the samples were dried for 24 hours and allowed to acclimate to room temperature for at least another 24 hours before being placed in the conditioning chamber.

Visual inspection of the samples was conducted on a monthly basis to examine for surface discoloration, any crystals or precipitation of the fire-retardant composition on the surface of the wood, brittleness of the sample, and record any other abnormal physical changes seen in the samples. Photographs and pH measurements were also taken. FIG. 3 depicts these photos including photos taken before treatment (“initial”), at 30 days, 90 days, and 180 days of exposure to the testing conditions in the conditioning chamber.

After 30 days in the conditioning chamber, all samples had a slight surface discoloration, changing from yellow to a light brown-golden color. All of the samples were similar in appearance (color) as the untreated sample and no darker (worse) than sample 16, the water-only treated sample. Sample 12, the ammonium phosphate containing FR composition appeared to be the darkest after 30 days. Also, none of the samples appeared to have any precipitation crystals or any noticeable brittleness after the 30 day testing period.

After 90 days of conditioning, the results were similar to that of the 30 day testing period. All samples appeared to be slightly darker. The darkening or discoloration of the wood was believed to be caused by a reaction in the wood components themselves, as the results were similar for the untreated and water-treated samples. This reaction in the wood components may be explained in that parts of the wood structure contain acid or constituents that can form acid compounds which react to the high heat and humidity of the conditioning chamber, causing acid hydrolysis to occur. The acid hydrolysis forms acid compounds like acetic acid, carboxylic acid, phosphoric acid and the like, causing the wood to prematurely thermally degrade. In particular, the ammonium phosphate containing FR composition sample, sample 12, visually appeared to be darkest, indicating that it was affected the most by the high heat and humidity. FR Composition 1, FR Composition 2, and FR Composition 3 each appeared to be affected by the high heat and humidity at a rate similar to the water-treated and untreated control samples. All these samples appeared much lighter (better), indicating a slower degradation than in sample 12.

After 180 days at 167° F./75% RH, the test was concluded and final inspection of each sample was taken. All samples appeared to be brown-dark brown in color and no sample had any noticeable fire retardant precipitation crystals on the surface. Physical handling and inspection of each sample indicated that the brittleness and surface texture of the samples was similar in nature, with the exception of sample # 12. Sample 12, the ammonium phosphate containing FR composition sample, exhibited the poorest appearance, brittleness and texture of the group. This indicated that sample 12 had the poorest thermal stability properties of any of the samples. The appearance of FR Composition 1, FR Composition 2, and FR Composition 3 similar to the water-treated and untreated control samples, indicating better resistant to high heat and humidity. This testing indicated that the thermal properties of FR Compositions 1-3 appear to be more stable and probably better at reducing acid hydrolysis than the ammonium phosphate containing FR composition sample 12.

The Examples listed below illustrate methods for preparing and treating various compositions according to the invention using commercially available guanidine phosphate and boric acid. The tables accompanying each Example show results from the ASTM E-69 fire tube test. This test evaluates the wood susceptibility to burn and combust in response to heat under a controlled laboratory testing conditions. The burning characteristics are then monitored for weight loss, maximum tube temperature, char height and after flame (flame out). Other parameters which are noted during the test, but not included in the results are flame/hole, smoke, after-glow and burning profile readings. These Examples below, illustrate methods for preparing alternative versions of the inventive composition. The methods described in these Examples are illustrative only, and are not intended to limit the invention in any manner and should not be construed to limit the scope of claims herein.

### EXAMPLES

### Example 1

5.0% aqueous fire-retardant solution using commercially available guanidine phosphate was prepared. At room temperature, 3 part GP and 2 part boric acid was added to 95 part water. The GP was added first and stirred until completely dissolved, usually less than 15 minutes. After the GP goes into solution, the BA was added, stirred until dissolved. The resulting solution is a clear liquid with a pH of 7.56, measured with a Mettler-Toledo MP 220 pH meter at room temperature.

The solution was used to treat wood samples for fire tube testing. The samples were pressured treated in a vacuum to 22-25″ of Hg followed by the addition of the treating solution. The treatment chamber was then applied with pressure at 120 psi. The treated wood was dried until the moisture content reached between 4%-10%. The samples were subjected to ASTM E-69 fire tube test and the results are shown in table 1. The data show wood treated with the 5% solution of the fire-retardant composition has good fire-retardant properties for all the listed parameters.

TABLE 1

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 5% GP + BA Solution | 2.52 | 31.45 | 540 | 1:12 | 25 |

### Example 2

5% solution of the fire-retardant composition was prepared with 2.5 part GP, 2.5 part boric acid and 95 part water. The final solution has a pH of 6.94. The solution was prepared, the fire tube sticks treated, pH measurement taken, and samples dried according to Example 1. The results show that treated wood with the fire-retardant composition has good fire performance properties.

TABLE 2

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 5% GP + BA Solution | 2.49 | 32.44 | 500 | 1:20 | 29 |

### Example 3

7.5% solution of the fire-retardant composition was prepared with 5.25 part GP, 2.25 part boric acid and 92.5 part water. The final solution has a pH of 7.49. The solution was prepared, the fire tube sticks treated, pH measurement taken, and samples dried according to Example 1. The results show that treated wood with the fire-retardant composition has good fire performance properties.

TABLE 3

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 7.5% GP + BA Solution | 3.02 | 25.23 | 480 | :40 | 25 |

### Example 4

7.5% solution of the fire-retardant composition was prepared with 5.25 part GP, 2.25 part boric acid and 92.5 part water. The final solution has a pH of 7.51. The solution was prepared, the fire tube sticks treated, pH measurement taken, and samples dried according to Example 1. The results show that treated wood with the fire-retardant composition has good fire performance properties.

TABLE 4

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 7.5% GP + BA Solution | 3.07 | 24.87 | 500 | :48 | 21 |

### Example 5

7.5% solution of the fire-retardant composition was prepared with 5.25 part GP, 2.25 part boric acid and 92.5 part water. The solution has a pH 7.49. The solution was made, the fire tube sticks treated, dried, and solution pH measured according to Example 1. The results are shown in table 5.

TABLE 5

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 7.5% GP + BA Solution | 3.52 | 21.47 | 400 | 0:00 | 21 |

### Example 6

7.5% solution of the fire-retardant composition was prepared with 5.25 part GP, 2.25 part boric acid and 92.5 part water. The solution has a pH 7.55. The solution was made, the fire tube sticks treated, dried, and solution pH measured according to Example 1. The results are shown in table 6.

TABLE 6

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 7.5% GP + BA Solution | 3.3 | 22.46 | 600 | 1:20 | 22 |

### Example 7

7.5% solution of the fire-retardant composition was prepared with 5.25 part GP, 2.25 part boric acid and 92.5 part water. The solution has a pH 7.55. The solution was made, the fire tube sticks treated, dried, and solution pH measured according to Example 1. The results are shown in table 7.

TABLE 7

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 7.5% GP + BA Solution | 3.59 | 31.28 | 600 | 2:06 | 30 |

### Example 8

10% solution of the fire-retardant composition was prepared with 7 part GP, 3 part boric acid and 90 part water. The solution has a pH 7.27. The solution was made, the fire tube sticks treated, dried, and solution pH measured according to Example 1. The results are in table 8. The composition has excellent fire-retardant properties.

TABLE 8

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 10% GP + BA Solution | 4.06 | 16.12 | 470 | 0:00 | 15 |

### Example 9

10% solution of the fire-retardant composition was prepared with 7 part GP, 3 part boric acid and 90 part water. The solution has a pH 7.27. All preparations were according to Example 8. The results are in table 9. The composition has excellent fire-retardant properties.

TABLE 9

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 10% GP + BA Solution | 3.96 | 16.07 | 400 | 0:00 | 20 |

### Example 10

10% solution of the fire-retardant composition was prepared with 7 part GP, 3 part boric acid and 90 part water. The solution has a pH 6.85. All preparations were according to Example 9. The results are in table 10. The composition has good fire-retardant properties.

TABLE 10

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 10% GP + BA Solution | 4.07 | 28.89 | 530 | 0:00 | 25 |

### Example 11

10% solution of the fire-retardant composition was prepared with 7 part GP, 3 part boric acid and 90 part water. The solution has a pH 6.85. All preparations were according to Example 10. The results are in table 11. The composition has excellent fire-retardant properties.

TABLE 11

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 10% GP + BA Solution | 3.99 | 14.44 | 400 | 0:00 | 22 |

### Example 12

11.5% solution of the fire-retardant composition consisting of 10.35 part GP, 1.15 part boric acid and 87.5 part water. The solution has a pH 8.11. All preparations were according to Example 10. The results are shown in table 12. The composition has excellent fire-retardant properties.

TABLE 12

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 11.5% GP + BA Solution | 4.6 | 15.56 | 370 | 0:00 | 14 |

### Example 13

11.5% solution of the fire-retardant composition consisting of 10.35 part GP, 1.15 part boric acid and 87.5 part water. The solution has a pH 8.11. All preparations were according to Example 10. The results are shown in table 13. The composition has excellent fire-retardant properties.

TABLE 13

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 11.5% GP + BA Solution | 4.5 | 23.14 | 420 | 0:00 | 14 |

### Example 14

12.5% solution of the fire-retardant composition consisting of 12.5 part GP and 87.5 part water. The solution has a pH 9.16. The results show the composition has excellent fire-retardant properties.

TABLE 14

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 12.5% GP + BA Solution | 4.9 | 20.79 | 410 | 0:00 | 18 |

### Example 15

12.5% solution of the fire-retardant composition consisting of 12.5 part GP and 87.5 part water. The solution has a pH 7.61. The results show the composition has excellent fire-retardant properties.

TABLE 15

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 12.5% GP + BA Solution | 5.01 | 19.16 | 460 | 0:00 | 18 |

### Example 16

12.5% solution of the fire-retardant composition consisting of 12.5 part GP and 87.5 part water. The solution has a pH 7.07. The results show the composition has excellent fire-retardant properties.

TABLE 16

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 12.5% GP + BA Solution | 5 | 14.46 | 450 | 0:00 | 15 |

### Example 17

12.5% solution of the fire-retardant composition consisting of 5 part GP, 3.75 part urea phosphate (UP), 3.75 part BA and 87.5 part water. The solution has a pH 7.10. The results show that a reduced amount of GP and by adding UP to the mixture, the composition still has excellent fire-retardant properties.

TABLE 17

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 12.5% GP + UP + BA Solution | 5.79 | 23.07 | 526.67 | 0:00 | 25.67 |

### Example 18

10% solution of the fire-retardant composition consisting of 4.0 part GP, 3.0 part urea phosphate (UP), 3.0 part BA and 90 part water. The solution has a pH 7.07. The results show good fire-retardant properties can be achieved even at a lower concentration using the solution from Example 17.

TABLE 18

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 10% GP + UP + BA Solution | 4.32 | 25.49 | 546.7 | 0:00 | 23.7 |

### Example 19

12.5% solution of the fire-retardant composition consisting of 5 part GP, 3.75 part diammonium phosphate (DAP), 3.75 part BA and 87.5 part water. The solution has a pH 6.90. The results show that by adding DAP, GP and BA as a mixture, the composition still has excellent fire-retardant properties.

TABLE 19

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 12.5% GP + DAP + BA Solution | 5.31 | 25.49 | 527 | 0:00 | 23.3 |

### Example 20

10% solution of the fire-retardant composition consisting of 4.0 part GP, 3.0 part diammonium phosphate (DAP), 3.0 part BA and 90 part water. The solution has a pH 7.12. The results show good fire-retardant properties can be achieved even at a lower concentration using the solution from Example 19.

TABLE 20

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 10% GP + DAP + BA Solution | 4.15 | 23.89 | 593 | 0:00 | 28 |

### Example 21

10% solution of the fire-retardant composition consisting of 7.0 part urea phosphate (UP), 3 part boric acid (BA) and 90 part water. The results in Table 21 show the composition has good fire-retardant properties.

TABLE 21

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 10% UP + BA Solution | 3.93 | 26.7 | 663 | 0:00 | 34 |

### Example 22

10% solution of the fire-retardant composition consisting of 4.0 part urea phosphate (UP), 6 part boric acid (BA) and 90 part water. The composition has excellent fire-retardant properties shown in Table 22.

TABLE 22

| | Active | | Max Fire | | |
|---|---|---|---|---|---|
| | Retention | Weight | Tube Temp. | After Flame | Char Height |
| Treatment | (lbs./ft³) | Loss (%) | (° F.) | (min/sec) | (″) |
| Untreated wood | 0 | >70.0 | >800 | >4 min. | 40 |
| 10% UP + BA Solution | 4.15 | 23.17 | 470 | 0:00 | 20.67 |

The fire-retardant compositions according to the invention present an improvement in fire-retardant characteristics over untreated wood, as demonstrated by the decrease in the amount of weight loss in the material and the reduced maximum temperature attained when exposed to flame (fire tube test), as seen in Tables 1-22, and FIGS. 1 and 2. The fire-retardant compositions according to the present invention also demonstrate improved thermal stability, as seen in FIG. 3, and that these compositions may reduce the rate at which acid hydrolysis occurs, when compared to conventional phosphate based fire retardants. These compositions demonstrated better fire retardant properties compared to untreated, water-treated and the commercially available ammonium phosphate fire-retardant compositions described above.

We claim:

1. A fire-retardant composition comprising a guanidine phosphate and a boron-containing compound.

2. The fire-retardant composition of claim 1, wherein the guanidine phosphate is mono-guanidine phosphate, di-guanidine phosphate, or tri-guanidine phosphate.

3. The fire-retardant composition of claim 2, wherein the guanidine phosphate is di-guanidine phosphate.

4. The fire-retardant composition of claim 1, wherein the boron-containing compound is boric acid.

5. The fire-retardant composition of claim 1, wherein the weight ratio of the guanidine phosphate to the boron-containing compound is between 100:1 and 1:100.

6. The fire-retardant composition of claim 1, wherein the weight ratio of the guanidine phosphate to the boron-containing compound is between 10:1 and 1:10.

7. The fire-retardant composition of claim 1, wherein the weight ratio of the guanidine phosphate to the boron-containing compound is between 10:2 and 4:6.

8. The fire-retardant composition of claim 1, wherein the weight ratio of the guanidine phosphate to the boron-containing compound is about 7:3.

9. The fire-retardant composition of claim 1, wherein the guanidine phosphate and boron-containing compound are in powder or granular form.

10. The fire-retardant of claim 9, wherein the composition can be pre-mixed as a blend or packed in layers.

11. The fire-retardant composition of claim 1, wherein the composition can be mixed with water to form an aqueous treating solution.

12. The fire-retardant composition of claim 11, wherein the weight concentration of the guanidine phosphate and the boron-containing compound to water is between 1.0% and 50.0%.

13. The fire-retardant composition of claim 11, wherein the weight concentration of the guanidine phosphate and the boron-containing compound to water is between 2.0% and 20.0%.

14. The fire-retardant composition of claim 11, wherein the weight concentration of the guanidine phosphate and the boron-containing compound to water is between 5.0% and 15.0%.

15. The fire-retardant composition of claim 1, further comprising a cellulosic material.

16. The fire-retardant composition of claim 15, wherein the cellulosic material is wood.

17. A method for preparing a fire-retardant cellulosic material, comprising the step of applying a fire-retardant composition comprising an aqueous solution of guanidine phosphate and a boron-containing compound to a cellulosic material, thereby rendering the cellulosic material fire retardant.

18. The method of claim 17, wherein the fire-retardant composition is applied to the cellulosic material under pressure.

19. The method of claim 17, wherein the boron-containing compound is boric acid.

20. The method of claim 17, wherein the weight ratio of the guanidine phosphate to the boron-containing compound is between 10:1 and 1:10.

21. The method of claim 17, wherein the weight concentration of the guanidine phosphate and the boron-containing compound to water is between 2.0% and 20.0%.

22. A method of preparing a fire-retardant composition, comprising mixing a guanidine phosphate and a boron-containing compound in a ratio of between 10:1 and 1:10.

23. The method of claim 22, wherein the weight ratio of the guanidine phosphate to the boron-containing compound is about 7:3.

24. The method of claim 22, wherein the boron-containing compound is boric acid.

25. The method of claim 22, further comprising mixing the guanidine phosphate and the boron-containing compound with water to form an aqueous solution wherein the weight concentration of the guanidine phosphate and the boron-containing compound to water is between 2.0% and 20.0%.

26. A cellulosic material produced by the method of claim 17.

27. A fire-retardant cellulosic material comprising a guanidine phosphate and a boron-containing compound.

28. The fire-retardant cellulosic material of claim 27, wherein the guanidine phosphate is di-guanidine phosphate.

29. The fire-retardant cellulosic material of claim 27, wherein the boron-containing compound is boric acid.

30. The fire-retardant cellulosic material of claim 27, wherein the weight ratio of the guanidine phosphate to the boron-containing compound is between 10:2 and 4:6.

31. The fire-retardant cellulosic material of claim 30, wherein the weight ratio of the guanidine phosphate to the boron-containing compound is about 7:3.

32. The fire-retardant cellulosic material of claim 29, wherein solid retention of the guanidine phosphate and boric acid is between 0.5 to 6.5 pounds per cubic foot.

33. The fire-retardant cellulosic material of claim 29, wherein the solid retention of the guanidine phosphate and boric acid is between 1.5 to 5.0 pounds per cubic foot.

34. The fire-retardant cellulosic material of claim 29, wherein the solid retention of the guanidine phosphate and boric acid is between 2.5 to 3.5 pounds per cubic foot.

35. The fire-retardant cellulosic material of claim 29, wherein a weight loss of the material is less than 50 percent when subjected to an ASTM E-69 Fire Tube Test for southern yellow pine plywood.

36. The fire-retardant cellulosic material of claim 29, wherein a weight loss of the material is less than 40 percent when subjected to an ASTM E-69 Fire Tube Test for southern yellow pine plywood.

37. The fire-retardant cellulosic material of claim 29, wherein a weight loss of the material is less than 30 percent when subjected to an ASTM E-69 Fire Tube Test for southern yellow pine plywood.
